(19) United States
(12) Patent Application Publication
(10) Pub. No.: US 2011/0093838 A1
(43) Pub. Date: Apr. 21, 2011

(54) MANAGING SPECULATIVE ASSIST THREADS

(75) Inventors: ROCH G. ARCHAMBAULT, TORONTO (CA); TONG CHEN, YORKTOWN HEIGHTS, NY (US); YAOQING GAO, TORONTO (CA); KHALED A. MOHAMMED, MISSISSAUGA (CA); JOHN K. O'BRIEN, YORKTOWN HEIGHTS, NY (US); GENNADY PEKHIMENKO, PITTSBURGH, PA (US); RAUL E. SILVERA, WOODBRIDGE (CA); ZEHRA N. SURA, YORKTOWN HEIGHTS, NY (US)

(73) Assignee: INTERNATIONAL BUSINESS MACHINES CORPORATION, ARMONK, NY (US)

(21) Appl. No.: 12/905,202

(22) Filed: Oct. 15, 2010

(30) Foreign Application Priority Data
Oct. 16, 2009 (CA) 2680597

(51) Int. Cl. G06F 9/45

(52) U.S. Cl. 717/158

(57) ABSTRACT

An illustrative embodiment provides a computer-implemented process for managing speculative assist threads for data pre-fetching that analyzes collected source code and cache profiling information to identify a code region containing a delinquent load instruction and generates an assist thread, including a value for a local version number, at a program entry point within the identified code region. Upon activation of the assist thread the local version number of the assist thread is compared to the global unique version number of the main thread for the identified code region and an iteration distance between the assist thread relative to the main thread is compared to a predefined value. The assist thread is executed when the local version number of the assist thread matches the global unique version number of the main thread, and the iteration distance between the assist thread relative to the main thread is within a predefined range of values.

### STATEMENT OF GOVERNMENT RIGHTS

This invention was made with Government support under Contract number HR0011-07- 9-0002 awarded by the Defense Advanced Research Projects Agency (DARPA). The Government has certain rights in this invention.

### CROSS REFERENCE TO RELATED APPLICATIONS

Pursuant to 35 U.S.C. 119, Applicant claims a right of priority to Canadian Patent Application No. 2,680,597 filed 16 Oct. 2009.

### BACKGROUND

This disclosure relates generally to a data processing system and, more specifically, to managing speculative assist threads for data pre-fetching within a data processing system.

Within a data processing system a processor thread may be forced to stall when the data needed for a subsequent computation is not readily available in the cache memory associated with the processor. Computation cycles lost while waiting for the data to be loaded typically impact the performance of the data processing system in a negative manner. The impact on performance is recognized by current trends in hardware design, as processor speeds have historically improved at a faster rate than memory speeds.

The effective use of processor caches is crucial to the performance of the programs in applications. Typically cache misses are not evenly distributed throughout a program. A small number of delinquent load instructions are responsible for most of the cache misses. Identification of delinquent load instructions is important in many cache optimization and instruction or data pre-fetching techniques.

Data pre-fetching is one typical technique used to reduce the number of memory stall cycles, and thus improve the performance of the data processing system. Data pre-fetching may be performed by hardware designed to detect specific memory access patterns, or by software through the use of special memory pre-fetch instructions, or a combination of hardware and software mechanisms.

Hardware data pre-fetching incurs minimal overhead, but is typically limited by the complexity of access patterns that are feasible to detect, and by the number and length of pre-fetch streams active at a time. Software data pre-fetching is flexible, but typically incurs some execution overhead associated with the pre-fetch instructions inserted within the application code.

With the availability of multi-core and multi-threading, helper threads called assist threads can be used to accelerate an application by exploiting data pre-fetch for the main thread. The assist thread technique may be useful, especially when an application does not exhibit enough parallelism to effectively use all available threads. Even though the assist thread requires extra hardware resources, a separate assist thread is typically useful for several reasons.

Firstly, pre-fetching using a separate thread allows the pre-fetch code to closely mimic arbitrary access patterns, or even tailor the stream of accesses to be more inclusive (e.g., by ignoring some control flow) or more exclusive (e.g., by skipping some accesses in a pre-fetch sequence). Also, hardware is evolving towards systems with hundreds of hardware threads, and in many usage contexts, it is likely that there will be more hardware threads available than the number that can be exploited by application-level parallelism. Furthermore, since the assist thread executes asynchronously, it is possible to run-ahead and pre-fetch a large number of accesses without being bound by the speed of the application thread.

The main thread and the assist thread typically run fully asynchronously after the assist thread is created. However, there are several issues with the use of assist threads. In one example, global variables, accessed by assist threads, may be modified by the main thread, which may result in invalid memory accesses. In another example, the assist threads may get scheduled to execute after the main thread is finished. In another example, assist threads may run much faster than the main thread, which causes cache pollution, or assist threads may run much slower than the main thread. In either case, the assist thread cannot help the main thread.

### SUMMARY

According to one embodiment, a computer-implemented process for managing speculative assist threads for data pre-fetching analyzes collected source code and cache profiling information to form analyzed code, identifies a code region containing a delinquent load instruction to form an identified code region, assigns a value of a global unique version number to a main thread for each instance of the identified code region, and generates an assist thread, including a value for a local version number, at a program entry point within the identified code region. The computer-implemented process further activates the assist thread in the identified code region, updates synchronization values, determines whether the local version number of the assist thread matches the global unique version number of the main thread for the identified code region and determines whether an iteration distance between the assist thread relative to the main thread is within a predefined range of values, responsive to a determination that the local version number of the assist thread matches the global unique version number of the main thread for the identified code region. The computer-implemented process further executes the assist thread, responsive to a determination that an iteration distance between the assist thread relative to the main thread is within a predefined range of values.

According to another embodiment, a computer program product for managing speculative assist threads for data pre-fetching is presented. The computer program product comprises a computer recordable-type media containing computer executable program code stored thereon. The computer executable program code comprises computer executable program code for analyzing collected source code and cache profiling information to form analyzed code, computer executable program code for identifying a code region containing a delinquent load instruction to form an identified code region, computer executable program code for assigning a value of a global unique version number to a main thread for each instance of the identified code region, computer executable program code for generating an assist thread, including a value for a local version number, at a program entry point within the identified code region, computer executable program code for activating the assist thread in the identified code region, computer executable program code for updating synchronization values, computer executable program code for determining whether the local version number of the assist thread matches the global unique version number of the main thread for the identified code region, computer executable program code for determining whether an iteration distance between the assist thread relative to the main thread is within a predefined range of values, responsive to a determination that the local version number of the assist thread matches the global unique version number of the main thread for the identified code region, and computer executable program code for executing the assist thread, responsive to a determination that an iteration distance between the assist thread relative to the main thread is within a predefined range of values.

According to another embodiment, an apparatus for managing speculative assist threads for data pre-fetching is presented. The apparatus comprises a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit executes the computer executable program code to direct the apparatus to analyze collected source code and cache profiling information to form analyzed code, identify a code region containing a delinquent load instruction to form an identified code region, assign a value of a global unique version number to a main thread for each instance of the identified code region, generate an assist thread, including a value for a local version number, at a program entry point within the identified code region, activate the assist thread in the identified code region, update synchronization values, determine whether the local version number of the assist thread matches the global unique version number of the main thread for the identified code region, determine whether an iteration distance between the assist thread relative to the main thread is within a predefined range of values, responsive to a determination that the local version number of the assist thread matches the global unique version number of the main thread for the identified code region, and execute the assist thread, responsive to a determination that an iteration distance between the assist thread relative to the main thread is within a predefined range of values.

### BRIEF DESCRIPTION OF THE SEVERAL VIEWS OF THE DRAWINGS

For a more complete understanding of this disclosure, reference is now made to the following brief description, taken in conjunction with the accompanying drawings and detailed description, wherein like reference numerals represent like parts.

FIG. 1 is a block diagram of an exemplary data processing system operable for various embodiments of the disclosure;

FIG. 2 is a block diagram of compilation system that may be implemented within the data processing system of FIG. 1, in accordance with various embodiments of the disclosure;

FIG. 3 is a flowchart of a version control process used in the compilation system of FIG. 2, in accordance with one embodiment of the disclosure;

FIG. 4 is a flowchart of distance control process used in the compilation system of FIG. 2, in accordance with one embodiment of the disclosure; and

FIG. 5 is a flowchart of a process to calculate block execution time used in the compilation system of FIG. 2, in accordance with one embodiment of the disclosure.

### DETAILED DESCRIPTION

Although an illustrative implementation of one or more embodiments is provided below, the disclosed systems and/or methods may be implemented using any number of techniques. This disclosure should in no way be limited to the illustrative implementations, drawings, and techniques illustrated below, including the exemplary designs and implementations illustrated and described herein, but may be modified within the scope of the appended claims along with their full scope of equivalents.

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, the present invention may take the form of a computer program product tangibly embodied in any medium of expression with computer usable program code embodied in the medium.

Any combination of one or more computer readable medium may be utilized. The computer readable medium may be a computer readable signal media or a computer readable storage media. A computer readable storage media may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing. In the context of this document, a computer readable storage media may be any tangible medium that can contain, or store a program for use by or in connection with an instruction execution system, apparatus or device.

A computer readable signal media may include a propagated data signal with computer readable program code embodied therein; for example, in baseband or as part of a carrier wave. Such a propagated signal may take any of a variety of forms, including, but not limited to, electromagnetic, optical or any suitable combination thereof. A computer readable signal media may be any computer readable medium that is not a computer readable storage media and that can communicate, propagate, or transport a program for use by or in connection with an instruction execution system, apparatus or device. Program code embodied in a computer readable signal media may be transmitted using any appropriate medium, including but not limited to wireless, wire line, optical fiber cable, RF, etc., or any suitable combination of the foregoing.

Computer program code for carrying out operations of the present disclosure may be written in any combination of one or more programming languages, including an object oriented programming language such as Java™, Smalltalk, C++, or the like and conventional procedural programming languages, such as the “C” programming language or similar programming languages. Java and all Java-based trademarks and logos are trademarks of Sun Microsystems, Inc., in the United States, other countries or both. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus, systems, and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer or other programmable data processing apparatus to function in a particular manner, such that the instructions stored in the computer readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide processes for implementing the functions/acts specified in the flowchart and/or block diagram block or blocks.

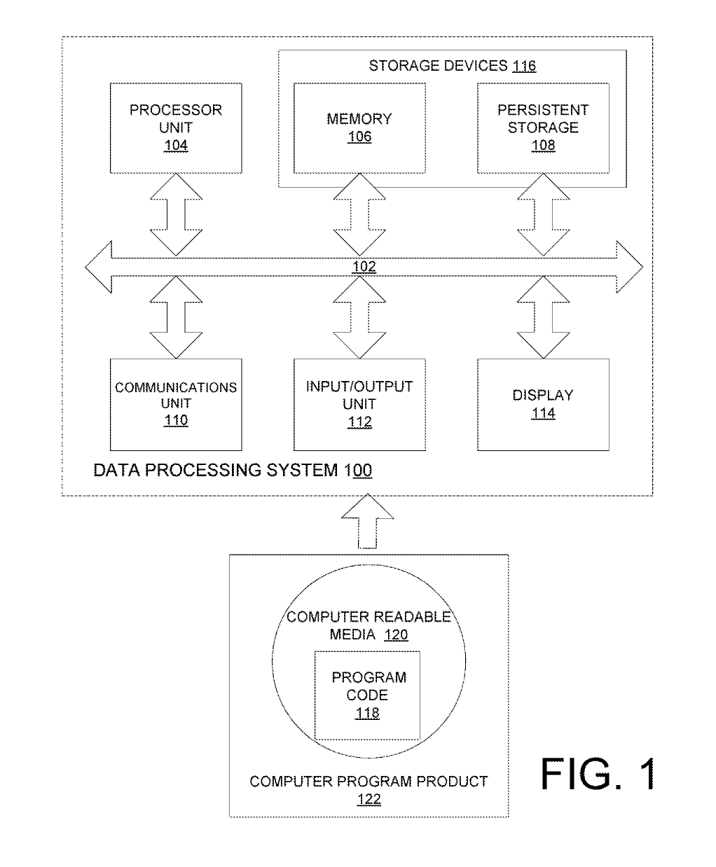

FIG. 1 is a block diagram of an exemplary data processing system operable for various embodiments of the disclosure. In this illustrative example, data processing system 100 includes communications fabric 102, which provides communications between processor unit 104, memory 106, persistent storage 108, communications unit 110, input/output (I/O) unit 112, and display 114.

Processor unit 104 serves to execute instructions for software that may be loaded into memory 106. Processor unit 104 may be a set of one or more processors, or may be a multi-processor core, depending on the particular implementation. Further, processor unit 104 may be implemented using one or more heterogeneous processor systems in which a main processor is present with secondary processors on a single chip. As another illustrative example, processor unit 104 may be a symmetric multi-processor system containing multiple processors of the same type.

Memory 106 and persistent storage 108 are examples of storage devices 116. A storage device is any piece of hardware that is capable of storing information; for example and without limitation, data, program code in functional form, and/or other suitable information either on a temporary basis and/or a permanent basis. In these examples, memory 106 may be, a random access memory or any other suitable volatile or non-volatile storage device. Persistent storage 108 may take various forms depending on the particular implementation. For example, persistent storage 108 may contain one or more components or devices, such as a hard drive, a flash memory, a rewritable optical disk, a rewritable magnetic tape, or some combination of the above. The media used by persistent storage 108 also may be removable, such as a removable hard drive.

Communications unit 110, in these examples, provides for communications with other data processing systems or devices. In these examples, communications unit 110 is a network interface card. Communications unit 110 may provide communications through the use of either or both physical and wireless communications links.

Input/output unit 112 allows for input and output of data with other devices that may be connected to data processing system 100. For example, input/output unit 112 may provide a connection for user input through a keyboard, a mouse, and/or some other suitable input device. Further, input/output unit 112 may send output to a printer. Display 114 provides a mechanism to display information to a user.

Instructions for the operating system, applications and/or programs may be located in storage devices 116, which are in communication with processor unit 104 through communications fabric 102. In these illustrative examples the instructions are in a functional form on persistent storage 108. These instructions may be loaded into memory 106 for execution by processor unit 104. The processes of the different embodiments of the current invention may be performed by processor unit 104 using computer-implemented instructions, which may be located in a memory, such as memory 106.

These instructions are referred to as program code, computer usable program code, or computer readable program code, which may be read and executed by a processor in processor unit 104. The program code in the different embodiments may be embodied on different physical or tangible computer readable media, such as memory 106 or persistent storage 108.

Program code 118 is located in a functional form on one or more computer readable medium 120, which may be selectively removable and may be loaded onto or transferred to data processing system 100 for execution by processor unit 104. Program code 118 and computer readable medium 120 form computer program product 122 in these examples. In one example, computer readable medium 120 may be in a tangible form; for example, an optical or magnetic disc that is inserted or placed into a drive or other device that is part of persistent storage 108 for transfer onto another storage device, such as a hard drive that is part of persistent storage 108. In a tangible form, computer readable medium 120 also may take the form of a persistent storage, such as a hard drive, a thumb drive, or a flash memory that is connected to data processing system 100. The tangible form of computer readable media 120 is also referred to as computer recordable storage media. In some instances, computer readable media 120 may not be removable.

Alternatively, program code 118 may be transferred to data processing system 100 from computer readable medium 120 through a communications link to communications unit 110 and/or through a connection to input/output unit 112. The communications link and/or the connection may be physical or wireless in the illustrative examples. The computer readable medium also may take the form of non-tangible medium, such as communications links or wireless transmissions containing the program code.

In some illustrative embodiments, program code 118 may be downloaded over a network to persistent storage 108 from another device or data processing system for use within data processing system 100. For instance, program code stored in a computer readable storage medium in a server data processing system may be downloaded over a network from the server to data processing system 100. The data processing system providing the program code 118 may be a server computer, a client computer, or some other device capable of storing and transmitting program code 118.

The different components illustrated for data processing system 100 are not meant to provide architectural limitations to the manner in which different embodiments may be implemented. The different illustrative embodiments may be implemented in a data processing system including components in addition to or in place of those illustrated for data processing system 100. Other components shown in FIG. 1 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 100 may be any hardware apparatus that may store data. Memory 106, persistent storage 108 and computer readable media 120 are examples of storage devices in a tangible form.

In another example, a bus system may be used to implement communications fabric 102 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 106 or a cache, such as found in an interface and memory controller hub that may be present in communications fabric 102.

According to an illustrative embodiment, a computer-implemented process for managing speculative assist threads for data pre-fetching is presented. Using data processing system 100 of FIG. 1 as an example, an illustrative embodiment provides the computer-implemented process stored in memory 106, and executed by processor unit 104. Processor unit 104 analyzes collected source code and cache profiling information received from storage devices 118, input/output unit 112 or communications unit 110 to form analyzed code, which may be stored within storage devices 118, such as memory 106 or persistent storage 108. Processor unit 104 identifies a code region containing a delinquent load instruction to form an identified code region, assigns a value of a global unique version number to a main thread for each instance of the identified code region, and generates an assist thread, including a value for a local version number, at a program entry point within the identified code region. Processor unit 104 further activates the assist thread in the identified code region, updates synchronization values, determines whether the local version number of the assist thread matches the global unique version number of the main thread for the identified code region, and determines whether an iteration distance between the assist thread relative to the main thread is equal to a predefined value, responsive to a determination that the local version number of the assist thread matches the global unique version number of the main thread for the identified code region. Processor unit 104 further executes the assist thread, responsive to a determination that an iteration distance between the assist thread relative to the main thread is equal to a predefined value.

In an alternative embodiment, program code 118 containing the computer-implemented process may be stored within one or more computer readable medium 120 as computer program product 122. In another illustrative embodiment, the process for managing speculative assist threads for data pre-fetching may be implemented in an apparatus comprising a communications fabric, a memory connected to the communications fabric, wherein the memory contains computer executable program code, a communications unit connected to the communications fabric, an input/output unit connected to the communications fabric, a display connected to the communications fabric, and a processor unit connected to the communications fabric. The processor unit of the apparatus executes the computer executable program code to direct the apparatus to perform the process.

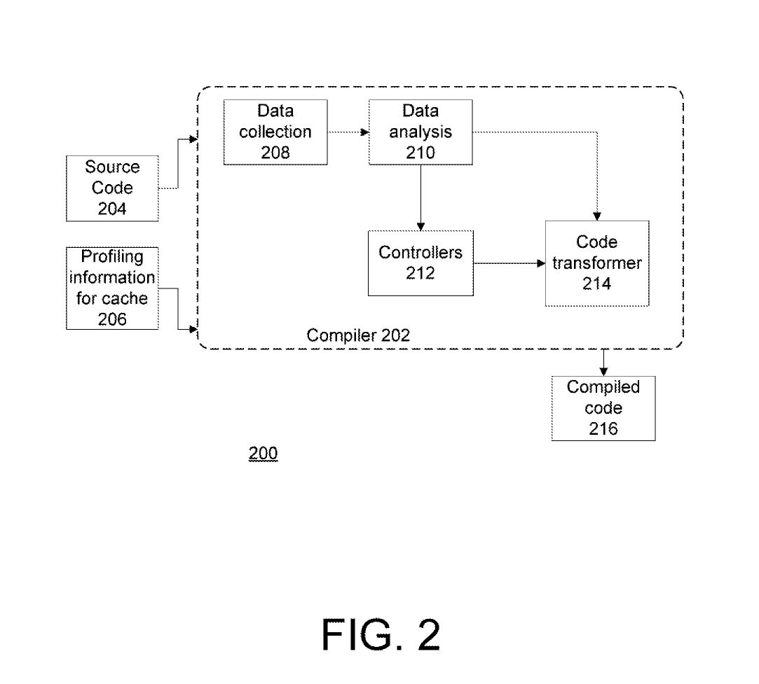

FIG. 2 is a block diagram of a compilation system that may be implemented within the data processing system of FIG. 1, in accordance with various embodiments of the disclosure. Compilation system 200 comprises a number of components necessary for compilation of source code into computer executable program code or computer executable instructions. Components of compiler system 200 include, but are not limited to, compiler 202, source code 204, profiling information for cache 206, data collection 208, data analysis 210, controllers 212, code transformer 214 and compiled code 216.

Compilation system 200 receives input into compiler 202 in the form of source code 204 and profiling information for cache 206. Source code 204 provides the programming language instructions for the application of interest. The application may be a code portion of an application, a function, procedure or other compilation unit for compilation. Profiling information for cache 206 represents information collected for cache accesses. The access information typically includes cache element hit and cache element miss data. The information may further include frequency, location, and count data.

Data collection 208 provides a capability to receive input from sources outside the compiler, as well as inside the compiler. The information is collected and processed using a component in the form of data analysis 210. Data analysis 210 performs statistical analysis of cache profiling data and other data received in data collection 208. Data analysis 210 comprises a set of services capable of analyzing the various types and quantity of information obtained in data collection 208. For example, if cache access information is obtained in data collection 208, data analysis 210 may be used to derive location and count information for each portion of the cache that is associated with a cache hit or a cache miss. Further, analysis may also be used to determine frequency of access for a cache location. Data analysis 210 also provides information on when and where to place assist threads designed to help in data pre-fetch operations. Data pre-fetch operations provide a capability to manage data access for just-in-time readiness in preparation for use by the application.

Controllers 212 provide a capability to manage the data pre-fetch activity. For example, controllers 212 may be used to monitor and adjust synchronization between a main thread of an application and an assist thread used to prime data for the main thread. Adjustment includes timing of the assist thread relative to the execution of the main thread. Controllers 212 provide a set of one or more control functions. The set of one or more control functions comprises capabilities including version control, distance control and loop blocking factors, which may be implemented as a set of one or more cooperating components.

Code transformer 214 provides a capability to modify the source code to typically insert assist thread function where needed. The functional integrity of the source code is not altered by placement of assist thread code. For example, when a code block is analyzed and a determination is made to add an assist thread, code transformer 214 provides the code representing the assist thread at the specific location within the main thread. Addition of the assist thread includes necessary setup and termination code for proper execution.

Compiled code 216 is the result of processing source code 204 and any profiling information for cache 206 through compiler 202. Compiled code 216 may or may not contain assist threads as determined by data analysis 210 and controllers 212.

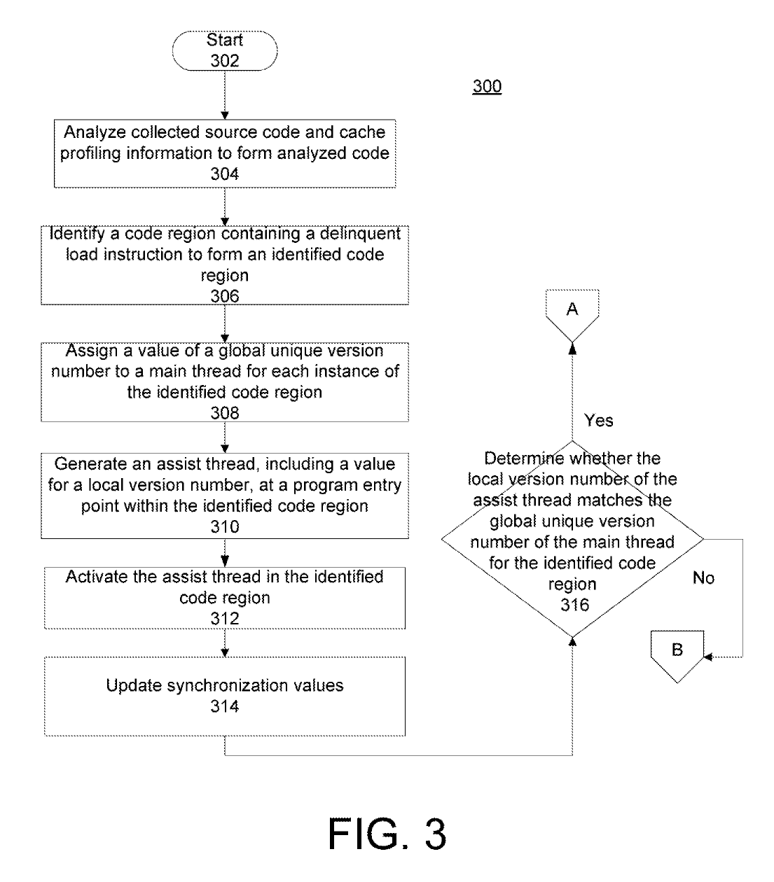

FIG. 3 is a flowchart of a version control process used in the compilation system of FIG. 2, in accordance with one embodiment of the disclosure. Version control is a process used in the context of synchronizing the activity of the assist thread relative to the main thread for which the assist is provided. Process 300 is an example of a process used to generate an assist thread and to manage synchronization between a main thread and the associated assist thread using a version number associated with a block of code of the main thread and a version number of a block of code of an assist thread within the respective block of code of the main thread.

Process 300 starts (step 302) and analyzes collected source code and cache profiling information to form analyzed code (step 304). The source code is analyzed with respect to several factors including identification of delinquent load loop selection, region cloning and back slicing. A load instruction becomes delinquent when a cache miss rate associated with the instruction is above a predefined threshold. Another determining factor or additional factor analyzed may be when an average latency calculated for a set of recent cache misses, associated with the load instructions, exceeds a predefined threshold. Other techniques, such as basic block profiling, may also be used to identify the load instructions that account for data cache misses.

Having identified a set of instructions containing one or more instructions including a delinquent load instruction, process (300) proceeds to identify a code region containing a delinquent load instruction to form an identified code region (step 306). The process then assigns a value of a global unique version number to a main thread for each instance of the identified code region (step 308).

The process then generates an assist thread including a value for a local version number at a program entry point within the identified code region (step 310). The assist threads are generated with speculative pre-computation for effective pre-fetching. Compiler 202 of FIG. 2 is used to generate code for the assist thread, and to synchronize assist thread execution with respect to the application thread. To generate assist thread code, the compiler may use techniques including static analysis, dynamic profiling information or combination thereof to determine which memory accesses to pre-fetch into cache. The memory accesses targeted for pre-fetching are called delinquent loads, such as, for example, the load instructions causing the most cache misses during code execution. The local version number is associated with the assist thread of the identified code region. The process then activates the assist thread in the identified code region (step 312). Activation initiates processing of the thread including whether the thread should execute. Process 300 updates synchronization values (step 314).

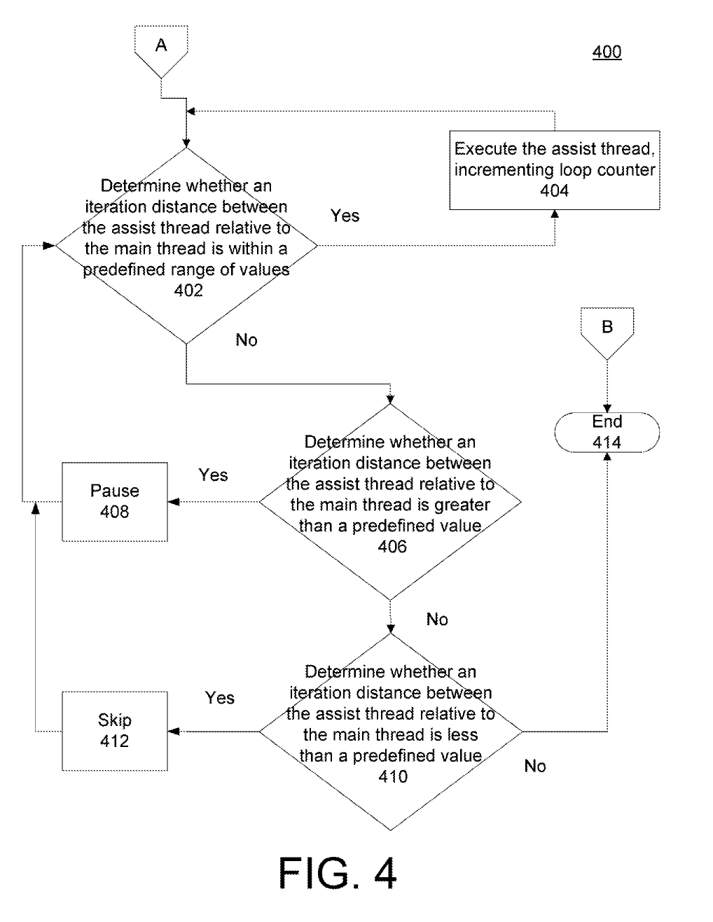

Process 300 determines whether the local version number of the assist thread matches the global unique version number of the main thread for the identified code region (step 316). The local version number of the assist thread and the global unique version number of the main thread for the identified code region match when the values are equal. When a determination is made that the local version number of the assist thread matches the global unique version number of the main thread for the identified code region, a “yes” is obtained. When a determination is made that the local version number of the assist thread does not match the global unique version number of the main thread for the identified code region, a “no” result is obtained. When a “yes” result is obtained in step 316, process 300 moves to step 402 of FIG. 4. When a “no” result is obtained in step 316, process 300 terminates (step 414 of FIG. 4).

The version numbers are used to synchronize the assist thread execution with the main thread: Version number comparison provides a coarse-grain control to reduce the probability of invalid memory accesses. The global unique version number is created for each instance of the code region where data pre-fetching with an assist thread is applied. For each call to wake up an assist thread, the version number is passed to the wake up function. When the assist thread is executed, the assist thread will first determine whether the global version value matches with the version value that is passed. For example, when a current global version number of 10 is created by the main thread, the value of 10 is passed to the assist thread for use in the comparison. When the assist thread is initiated, a determination is made as to whether the global version number still matches the local version number of 10. When the version number fails to match, the assist thread exits. When the main thread finishes executing a code region, the main thread will increase the global version number.

For further control, delinquent loads that are contained within loops may be used to filter the number of assist threads to create. Although a loop may not exist initially, a loop may be materialized after in-line code is created. The loop may also be eliminated through loop unrolling techniques. The compiler also uses a back-slicing algorithm to determine the code sequence that will execute in the assist thread. The back slicing algorithm is also used to compute the memory addresses corresponding to the delinquent loads that are to be pre-fetched. The back-slicing algorithm operates on the identified region of code containing the delinquent load. The region of code may correspond to a portion of code containing a loop nest, or some level of inner loops within a nest. The generated assist thread code is created to maintain the visible state for the application. The code generated for the application thread is thus minimally changed when an assist thread is being used. These generated changes include creating an assist thread once at the program entry point, activating assist thread pre-fetching at the entry to regions containing delinquent loads, loop blocking and updating synchronization variables where applicable.

As part of static analysis to avoid possible runtime exceptions, after delinquent loads are identified, the compiler performs back slicing. For example, compiler 202 of FIG. 2 back slices by starting from the address expressions for all delinquent loads, and performs backward traversal of data and control dependence edges to find all statements needed for address calculation and to remove unnecessary statements from the slice. Stores to global variables terminate the chain of dependences being followed, and localization is applied when possible. The back slicing process keeps track of local live-ins to the slice code and inserts pre-fetch instructions into the slice, or code region. During back slicing, possible exceptions and invalid memory accesses are identified to avoid unnecessary runtime exceptions.

FIG. 4 is a flowchart of a distance control process used in the compilation system of FIG. 2, in accordance with one embodiment of the disclosure. Process 400 is an example of a synchronization control used within compiler 202 of FIG. 2.

The compiler can transform source code to insert code for synchronization between the main thread and the assist thread. Process 400 continues from step 316 of process 300 of FIG. 3 and determines whether an iteration distance between the assist thread relative to the main thread is within a predefined range of values (step 402). When a determination is made that the iteration distance between the assist thread relative to the main thread is within a predefined range of values, a “yes” value is obtained. When a determination is made that the iteration distance between the assist thread relative to the main thread is not within a predefined range of values, a “no” value is obtained. The predefined range of values is used to keep execution of both threads within a predefined number of loop iterations of each other.

When a “yes” is obtained in step 402, execute the assist thread; incrementing a loop counter is performed 404. Process 400 loops back to step 402. When a “no” is obtained in step 402, the process determines whether an iteration distance between the assist thread relative to the main thread is greater than a predefined value (step 406). When a determination is made that the iteration distance between the assist thread relative to the main thread is greater than a predefined value, a “yes” value is obtained. When a determination is made that the iteration distance between the assist thread relative to the main thread is not greater than a predefined value, a “no” value is obtained.

When a “yes” is obtained in step 406, process 400 causes the assist thread to pause (step 408). The pause may be specified in various units for a predetermined value, including the form of a period of time, a number of cycles, or iterations of a loop. Process 400 loops back to step 402. When a “no” is obtained in step 406, the process determines whether an iteration distance between the assist thread relative to the main thread is less than a predefined value (step 410). When a determination is made that the iteration distance between the assist thread relative to the main thread is less than a predefined value, a “yes” value is obtained. When a determination is made that the iteration distance between the assist thread relative to the main thread is not less than a predefined value, a “no” value is obtained.

When a “no” value is received in step 410, process 400 terminates (step 414). When a “yes” value is received in step 410, process 400 causes the assist thread to skip (step 412). The number of units to skip may be specified in various units for a predetermined value, including the form of, a period of time, a number of cycles, or iterations of a loop. Process 400 then loops back to step 402.

When a determination is made that the overhead is high and it is not profitable, the assist thread is programmed to avoid synchronization altogether, thereby avoiding the steps of process 400.

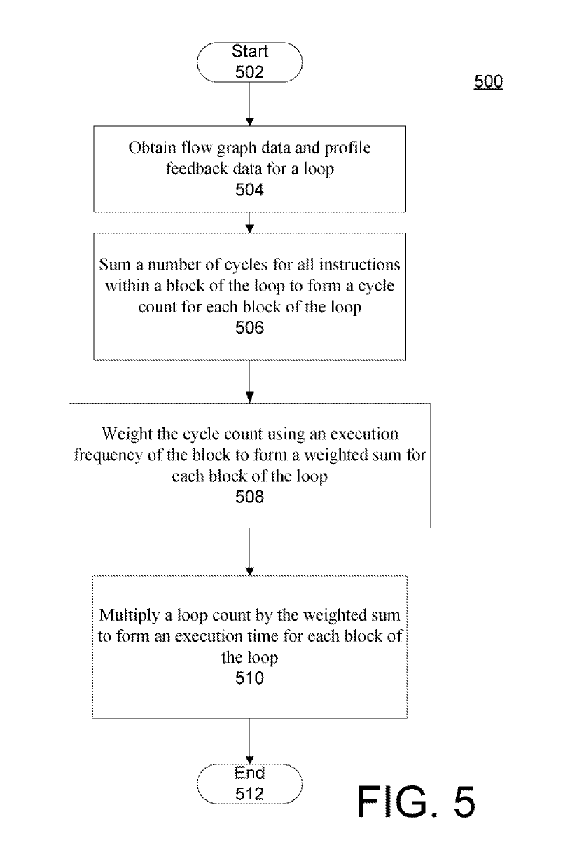

FIG. 5 is a flowchart of a process to calculate block execution time used in the compilation system of FIG. 2, in accordance with one embodiment of the disclosure.

Process 500 is an example of a process within the compiler to determine synchronization transformations to apply in the case of each delinquent load. Compiler 202 using information from data collection 208 processed by data analysis 210 and controllers 212, all of FIG. 2, determines synchronization transformations to apply in the case of each delinquent load. Loop blocking is a technique used to further reduce the overhead of distance control. Process 500 relies on a heuristic to estimate the execution times for an iteration of a loop in the assist thread pre-fetch code, and for an iteration of a loop in the main application code assuming successful data pre-fetching.

Process 500 starts (step 502) and obtains flow graph and profile feedback data for a loop (step 504). Sum a number of cycles for all instructions within a block of the loop to form a cycle count for each block of the loop is performed (step 506). Process 500 weights the cycle count using an execution frequency for the block to form a weighted sum for each block of the loop (step 508). Process 500 multiplies a loop count by the weighted sum to form an execution time for each block of the loop (step 510) terminating thereafter (step 512).

Using the example of process 500, a time limit of 30 cycles may be established as a predefined value. When an improvement is needed and the difference between the assist thread time and the main thread time is less than the predefined value, then the compiler transforms the assist thread code so that the assist thread periodically skips some loop iterations. When an improvement is needed and the difference between the assist thread time and the main thread time is greater than the predefined value, then the compiler transforms the assist thread code so that the assist thread periodically pauses or waits. In one example, the number of iterations to skip or synchronize is estimated, in terms of a number of cache lines used for all load instructions in a loop associated with the assist thread, as an amount of level two cache available for pre-fetching divided by an amount of data fetched within an iteration of the loop associated with the assist thread.

By a further example, estimates of execution time may use the flow graph and profile directed feedback data as available in the compiler. The profiling data typically includes cache miss rates for individual memory instructions, percent execution frequencies for basic blocks, and loop iteration counts. Cycle counts are typically dependent upon the hardware platform and may be adjusted accordingly. Initially, the number of cycles for each basic block is computed as the sum of cycles for each instruction in the block. One cycle is assigned for almost all data manipulation instructions; however two cycles may be assigned for multiplication and fifteen cycles for division. For memory instructions, a formula of ((miss latency*miss rate)+2*(1−miss rate)) may be used, with the exception that when the memory operation is in both threads, then the miss rate in the main thread is assumed to be zero.

To further reduce the overhead associated with distance control, a well-known technique of loop blocking may be added to control the distance for each block rather than for an iteration of the loop. Both the main thread and assist thread use the same blocking factor and distance control code is inserted out of the blocked loop.

Illustrative embodiments thus provide a process, a computer program product and an apparatus for managing speculative assist threads for data pre-fetching. One illustrative embodiment provides a computer-implemented process for analyzing collected source code and cache profiling information to form analyzed code, identifying a code region containing a delinquent load instruction to form an identified code region, assigning a value of a global unique version number to a main thread for each instance of the identified code region, and generating an assist thread, including a value for a local version number, at a program entry point within the identified code region. The computer-implemented process further activates the assist thread in the identified code region, updates synchronization values, determines whether the local version number of the assist thread matches the global unique version number of the main thread for the identified code region and determines whether an iteration distance between the assist thread relative to the main thread is within a predefined range of values, responsive to a determination that the local version number of the assist thread matches the global unique version number of the main thread for the identified code region. The computer-implemented process further executes the assist thread, responsive to a determination that an iteration distance between the assist thread relative to the main thread is within a predefined range of values.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing a specified logical function. It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes, but is not limited to firmware, resident software, microcode, and other software media that may be recognized by one skilled in the art.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, radio frequency and light wave transmissions. The computer readable media may take the form of coded formats that are decoded for actual use in a particular data processing system.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems, and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, comprising:
analyzing, via a compiler, source code and cache profiling information;
identifying a code region of a main thread containing a delinquent load instruction;
assigning a global version number to the main thread for the code region;
generating an assist thread, including a local version number, at an entry point within the code region of the main thread;
determining whether the local version number of the assist thread matches the global version number of the main thread for the code region;
determining, in response to the local version number matching the global version number, whether an iteration distance between the assist thread relative to the main thread is within a predefined range; and
executing, in response to determining that the iteration distance is within the predefined range, the assist thread.

2. The method of claim 1, further comprising:
determining, in response to determining that the iteration distance is not within the predefined range, whether the iteration distance is greater than a first value; and
pausing the assist thread in response to determining that the iteration distance is greater than the first value.

3. The method of claim 2, further comprising:
determining, in response to determining that the iteration distance is not greater than the first value, whether the iteration distance is less than a second value; and
skipping a number of iterations of a loop associated with the assist thread in response to determining that the iteration distance is less than the second value.

4. The method of claim 3, where the number of iterations to skip is estimated in terms of a number of cache lines used for all load instructions in the loop associated with the assist thread, as an amount of level two cache available for pre-fetching divided by an amount of data fetched within one iteration of the loop associated with the assist thread.

5. The method of claim 1, further comprising:
terminating the assist thread in response to determining that the local version number does not match the global version number.

6. The method of claim 1, further comprising:
determining a number of cycles for all instructions within a block of a loop of the assist thread to form a first cycle count;
weighting the first cycle count using an execution frequency for the block of the loop of the assist thread to form a first weighted sum;
multiplying a loop count of the assist thread by the first weighted sum to form a first estimated execution time;
determining a number of cycles for all instructions within a block of a loop of the main thread to form a second cycle count;
weighting the second cycle count using an execution frequency for the block of the loop of the main thread to form a second weighted sum; and
multiplying a loop count of the main thread by the second weighted sum to form a second estimated execution time.

7. The method of claim 6, further comprising:
comparing a difference between the first estimated execution time and the second estimated execution time to a predefined value;
causing the assist thread to skip at least one loop iteration in response to the difference between the first estimated execution time and the second estimated execution time being less than the predefined value; and
causing the assist thread to pause in response to the difference between the first estimated execution time and the second estimated execution time being greater than the predefined value.

8. A computer program product comprising a computer readable storage medium having computer readable program code embodied therewith, the computer readable program code comprising:
computer readable program code configured to analyze source code and cache profiling information;
computer readable program code configured to identify a code region of a main thread containing a delinquent load instruction;
computer readable program code configured to assign a global version number to the main thread for the code region;
computer readable program code configured to generate an assist thread, including a local version number, at an entry point within the code region of the main thread;
computer readable program code configured to determine whether the local version number of the assist thread matches the global version number of the main thread for the code region;
computer readable program code configured to determine, in response to the local version number matching the global version number, whether an iteration distance between the assist thread relative to the main thread is within a predefined range; and
computer readable program code configured to execute, in response to determining that the iteration distance is within the predefined range, the assist thread.

9. The computer program product of claim 8, further comprising:
computer readable program code configured to determine, in response to determining that the iteration distance is not within the predefined range, whether the iteration distance is greater than a first value; and
computer readable program code configured to pause the assist thread in response to determining that the iteration distance is greater than the first value.

10. The computer program product of claim 9, further comprising:
computer readable program code configured to determine, in response to determining that the iteration distance is not greater than the first value, whether the iteration distance is less than a second value; and
computer readable program code configured to skip a number of iterations of a loop associated with the assist thread in response to determining that the iteration distance is less than the second value.

11. The computer program product of claim 10, where the number of iterations to skip is estimated in terms of a number of cache lines used for all load instructions in the loop associated with the assist thread, as an amount of level two cache available for pre-fetching divided by an amount of data fetched within one iteration of the loop associated with the assist thread.

12. The computer program product of claim 8, further comprising:
computer readable program code configured to terminate the assist thread in response to determining that the local version number does not match the global version number.

13. The computer program product of claim 8, further comprising:
computer readable program code configured to determine a number of cycles for all instructions within a block of a loop of the assist thread to form a first cycle count;
computer readable program code configured to weight the first cycle count using an execution frequency for the block of the loop of the assist thread to form a first weighted sum;
computer readable program code configured to multiply a loop count of the assist thread by the first weighted sum to form a first estimated execution time;
computer readable program code configured to determine a number of cycles for all instructions within a block of a loop of the main thread to form a second cycle count;
computer readable program code configured to weight the second cycle count using an execution frequency for the block of the loop of the main thread to form a second weighted sum;
and
computer readable program code configured to multiply a loop count of the main thread by the second weighted sum to form a second estimated execution time.

14. The computer program product of claim 13, further comprising:
computer readable program code configured to compare a difference between the first estimated execution time and the second estimated execution time to a predefined value;
computer readable program code configured to cause the assist thread to skip at least one loop iteration in response to the difference between the first estimated execution time and the second estimated execution time being less than the predefined value; and
computer readable program code configured to cause the assist thread to pause in response to the difference between the first estimated execution time and the second estimated execution time being greater than the predefined value.

15. An apparatus, comprising:
a storage device comprising computer executable program code;
a processor coupled to the storage device, where the processor executes the computer executable program code to direct the apparatus to:
analyze source code and cache profiling information;
identify a code region of a main thread containing a delinquent load instruction;
assign a global version number to the main thread for the code region;
generate an assist thread, including a local version number, at an entry point within the code region of the main thread;
determine whether the local version number of the assist thread matches the global version number of the main thread for the code region;
determine, in response to the local version number matching the global version number, whether an iteration distance between the assist thread relative to the main thread is within a predefined range; and
execute, in response to determining that the iteration distance is within the predefined range, the assist thread.

16. The apparatus of claim 15, where the processor further executes the computer executable program code to direct the apparatus to:
determine, in response to determining that the iteration distance is not within the predefined range, whether the iteration distance is greater than a first value; and
pause the assist thread in response to determining that the iteration distance is greater than the first value.

17. The apparatus of claim 16, where the processor further executes the computer executable program code to direct the apparatus to:
determine, in response to determining that the iteration distance is not greater than the first value, whether the iteration distance is less than a second value; and
skipping a number of iterations of a loop associated with the assist thread in response to determining that the iteration distance is less than the second value.

18. The apparatus of claim 17, where the number of iterations to skip is estimated in terms of a number of cache lines used for all load instructions in the loop associated with the assist thread, as an amount of level two cache available for pre-fetching divided by an amount of data fetched within one iteration of the loop associated with the assist thread.

19. The apparatus of claim 15, where the processor further executes the computer executable program code to direct the apparatus to:
terminate the assist thread in response to determining that the local version number does not match the global version number.

20. The apparatus of claim 15, where the processor further executes the computer executable program code to direct the apparatus to:
determine a number of cycles for all instructions within a block of a loop of the assist thread to form a first cycle count;
weight the first cycle count using an execution frequency for the block of the loop of the assist thread to form a first weighted sum;
multiply a loop count of the assist thread by the first weighted sum to form a first estimated execution time;
determine a number of cycles for all instructions within a block of a loop of the main thread to form a second cycle count;
weight the second cycle count using an execution frequency for the block of the loop of the main thread to form a second weighted sum; and
multiply a loop count of the main thread by the second weighted sum to form a second estimated execution time.
